(19) United States
(12) Patent Application Publication
(10) Pub. No.: US 2015/0086346 A1
(43) Pub. Date: Mar. 26, 2015

(54) LAVAL NOZZLE

(71) Applicant: Mahle International GmbH, Stuttgart (DE)

(72) Inventors: Rolf Mueller, Steinheim/Murr (DE); Holger Oechslen, Stuttgart (DE); Peter Wieske, Korntal-Muenchingen (DE)

(21) Appl. No.: 14/490,347

(22) Filed: Sep. 18, 2014

(30) Foreign Application Priority Data
Sep. 20, 2013 (DE) 102013218887.0

(51) Int. Cl. F01D 1/04; F01D 9/02

(52) U.S. Cl. CPC F01D 1/04; F01D 9/02; F05D 2240/128
USPC 415/202; 29/889.2

(57) ABSTRACT

A Laval nozzle may include a convergent duct section having a first longitudinal axis for accelerating a flow of a working fluid from a subsonic speed to a sonic speed. The Laval nozzle may include a divergent duct section, which is fluid-connected to the convergent duct section. The divergent duct section may have a second longitudinal axis for further accelerating the flow from the sonic speed to a supersonic speed. The convergent duct section and the divergent duct section may be aligned with respect to each other such that the first longitudinal axis intersects the second longitudinal axis.

### CROSS-REFERENCE TO RELATED APPLICATION

This application claims priority to German Patent Application No. 10 2013 218 887.0 filed Sep. 20, 2013, the contents of which are hereby incorporated by reference in their entirety.

### TECHNICAL FIELD

The invention relates to a Laval nozzle according to the preamble of claim 1 and to a turbine according to the preamble of claim 3. The invention also relates to a production method according to the preamble of claim 6.

### BACKGROUND

Flow or fluid energy machines, which convert the energy of a flowing fluid, referred to as enthalpy, into rotation energy and thus ultimately into mechanical work, are known in energy and drive technology under the umbrella term turbines. Generic turbines are used for example in the recovery of heat from combustion waste gases by means of a suitable thermodynamic cycle process. To this end, some of the kinetic, potential or pressure energy of a working medium of the thermodynamic cycle process is drawn from the mass flow of said working medium as it flows around the turbine blades with as little eddying as possible and is transferred to the rotor of the turbine. The rotor for its part transfers the work performed on it to a rotatably mounted turbine shaft, which can pass the usable power to a coupled work machine, for example a generator or to support an internal combustion engine.

For the flow-optimized loading of the rotor, a fluid element, referred to as a Laval nozzle in the turbomachinery field, is often used, said fluid element having a cross section that is initially convergent in the inlet region and then increasingly divergent downstream of a narrow transition region. The specific geometry of such a Laval nozzle makes it possible to accelerate the subsonic flow of the fluid to sonic speed along the convergent section until a constant narrow point is reached and to accelerate it further to supersonic speed in the subsequent divergent section, without significant compression shocks occurring.

However, the low tolerance of the mutually adjacent contours of the flow conduit proves a disadvantage in manufacturing terms. For instance, even a small offset along the transition edge between two adjacent sections of the Laval nozzle can result in undesirable turbulence in the flow during use of said nozzle, which cancels out the intended acceleration effect.

### SUMMARY

The invention is therefore based on the object of providing a Laval nozzle and a corresponding turbine that achieve the highest possible level of efficiency with a reasonable outlay on manufacturing. The invention is also based on the object of creating a cost-effective method for producing such a nozzle.

These objects are achieved by means of a Laval nozzle having the features of claim 1, a turbine having the features of claim 3, and by means of a corresponding production method having the features of claim 6.

The invention is accordingly based on the basic concept of deviating from the established geometry of a Laval nozzle having concentric duct sections in favour of an angled arrangement. This shape variant is based on the finding that the flow dynamics inherent in the generic Laval nozzle are largely retained as long as the longitudinal axes of the duct sections spatially intersect at least at one point rather than being superposed.

From this standpoint, an intersection angle between 5° and 85° proves particularly recommendable to achieve a compact shape of the resulting Laval nozzle on the one hand, but also to avoid massive burbling or sudden changes in the flow state, known in aerodynamics as compression shocks, on the part of the working fluid. The flow thus changes continuously from the subsonic to the supersonic range.

An advantageous field of use of the Laval nozzle according to the invention is heat recovery, for example from combustion waste gases. Precisely in automotive engineering, the space-saving shape of the Laval nozzle has considerable advantages over conventional approaches in view of the greatly restricted installation space. For instance, the proposed Laval nozzle can be used to set the rotor of a turbine and thus the output shaft thereof in continuous rotation by means of the working fluid, so that said shaft performs mechanical output work that can serve a motor vehicle as a source of kinetic energy. The enthalpy of the working fluid is converted particularly efficiently into mechanical drive energy in the manner described.

In this scenario, an entry of the flow exiting from the Laval nozzle into the rotor at an angle between 5° and 45° permits a largely eddy-free flow around the turbine blades at a high speed. A considerable portion of the thermal energy of the mass flow exiting the combustion chamber can thus be made useful, to reduce the primary energy consumption of the motor vehicle to a functionally necessary minimum and to avoid unnecessary emission of carbon dioxide (CO₂).

The efficiency of the heat recovery can be increased further if not just one but several, in particular at least three, Laval nozzles are fluid-connected at the same time to the rotor. The intended flow-accelerating effect can likewise be multiplied in such an arrangement, the redundancy of the proposed configuration also increasing the failure-safety of the device as a whole, which is of fundamental importance precisely in automotive engineering.

To realize a Laval nozzle according to the invention, a person skilled in the art can however make use of a production method that is based on machine-cutting a single-piece base body on two opposite sides. Particularly suitable is a flat workpiece, which is substantially even in its reference state, consists of rigid material and is referred to as a plate in the technical terminology of mechanical and construction engineering.

If the workpiece is shaped on both sides along two intersecting longitudinal axes, with a suitable configuration two duct sections in the above-described relative alignment are produced, which are connected in an opening inside the workpiece and thus allow fluid exchange according to the working principle of a Laval nozzle. Machine-cutting according to the documentation system of DIN 8589 means any machining method in which the desired duct sections are made in the workpiece by removing excess material in the form of chips. In the present case, the use of a tool edge having a defined, usually wedge-shaped geometry, which is familiar to a manufacturing engineer as a geometrically defined edge, is recommended for this purpose.

Since the duct sections according to this approach are formed as substantially hollow cylindrical depressions in the workpiece, drilling as standardized in DIN 8589-2, in which a drilling tool rotating about the respective longitudinal axis is pushed linearly along the same axis into the workpiece, is particularly conceivable from a process technology standpoint. Alternatively, what is known as milling according to DIN 8589-3, in which a corresponding milling tool, for example a ball-cutting tool, is used instead of the drilling tool, can be considered. The relative advancing movement necessary for the shaping can be generated by displacing either the workpiece clamped in a machine table or the milling tool itself around the workpiece, which opens up a multiplicity of suitable method variants in terms of manufacturing practice to a person skilled in the art.

As soon as the shaping is complete on the outlet side of the workpiece, into which both the divergent and the constant, narrowest duct section of the Laval nozzle to be manufactured is to open, the still remaining shaping of the inlet side can be carried out as follows: A ball-cutting tool sunk into the workpiece to the predefined target depth of the convergent duct section is moved in its operating state along the surface in the direction of the divergent duct section until the latter connects with the hollow formed in this manner. The subsequent measurement of the opening produced makes it possible to determine by calculation the distance still to be covered by the ball-cutting tool to its geometric end point, at which the opening, which is gradually widened in the course of the milling movement, will reach its—again predefined—final extent.

Post-machining of the opening after the manufacturing process allows any edges, which could result in the formation of turbulence in the flow field of the Laval nozzle in the unmachined state, to be smoothed or rounded. In contrast to the primary shaping phase of the production process, in this case an irregularly shaped, “geometrically undefined” edge can be used to remove the edges by machine cutting. Jet cutting, which is standardized in DIN 8200 and in the present connection is used for example according to the working principle of jet blasting or deburring, offers advantages. The use of this technology opens up numerous usable abrasive additives, jet media and acceleration methods to a person skilled in the art.

Further important features and advantages of the invention can be found in the subclaims, the drawings and the associated description of the figures using the drawings.

It is self-evident that the above-mentioned features and those still to be explained below can be used not only in the combination given in each case but also in other combinations or alone without departing from the scope of the present invention.

Preferred exemplary embodiments of the invention are shown in the drawings and are explained in more detail in the description below, the same reference symbols referring to the same or similar or functionally equivalent components.

### BRIEF DESCRIPTION OF THE DRAWINGS

In the figures,

FIG. 1 schematically shows a turbine according to the invention used for heat recovery,

FIG. 2 schematically shows the longitudinal section through a workpiece in a first method phase of the production of a Laval nozzle according to an embodiment of the invention,

FIG. 3 schematically shows a sectional diagram corresponding to FIG. 2 in a second method phase,

FIG. 4 schematically shows a sectional diagram corresponding to FIG. 2 in a third method phase, and

FIG. 5 schematically shows a sectional diagram corresponding to FIG. 2 in a fourth method phase.

### DETAILED DESCRIPTION

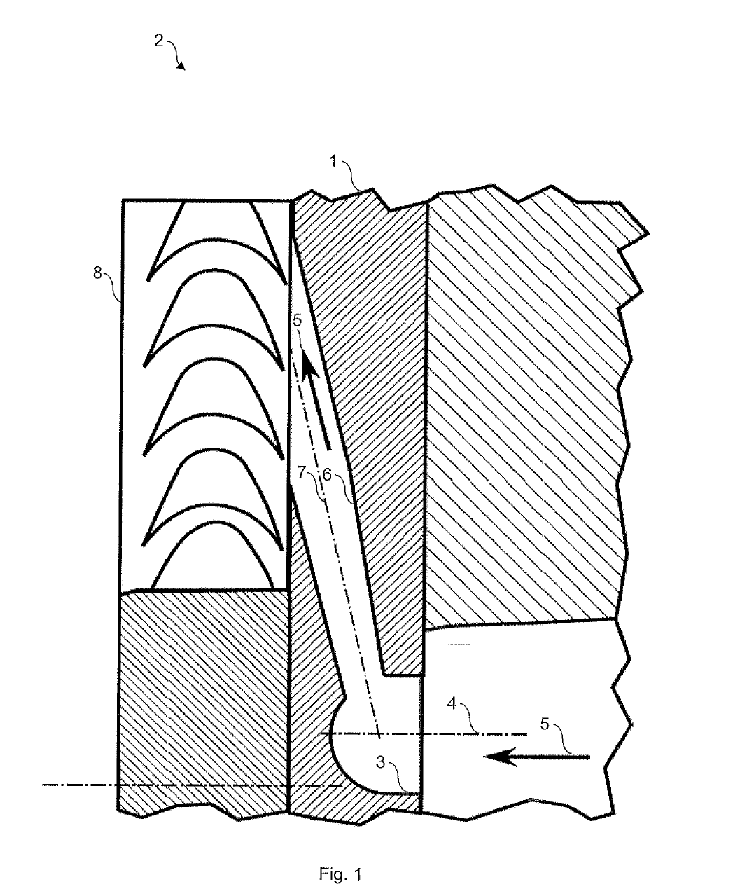

The regional sectional diagram of FIG. 1 illustrates the structure in principle of a turbine 2, which is characterized by its inventive Laval nozzle 1. A rotatably mounted output shaft (not shown in FIG. 1) of the turbine 2 bears a rotor 8, which is fluid-connected to the Laval nozzle 1 and can in principle be set in rotation in a conventional manner by the flow 5 of a working fluid conducted by the Laval nozzle 1.

However, the structure of the Laval nozzle 1, which is arranged centrally according to the diagram of FIG. 1 and is composed in particular of a convergent duct section 3, which has a first longitudinal axis 4, and of a divergent duct section 6, which is fluid-connected to the section 3 and has a second longitudinal axis 7, and of a constant narrowest cross section, proves characteristic. The flow 5 is directed initially approximately parallel to the first longitudinal axis 4 of the convergent duct section 3 when it enters the Laval nozzle 1, from the right in the figure.

The hollow cylindrical entry region of the convergent duct section 3 merges even at a shallow depth into a convex, virtually hollow spherical depression, which gives the convergent duct section 3 as a whole the shape of a hollow or indentation owing to the continuous narrowing of its walls. The blind-hole-like curvature formed in this manner opens on one side into the constant and subsequently divergent duct section 6, the second longitudinal axis 7 of which intersects the first longitudinal axis 4 at an angle of 80° approximately in the centre point of the hollow spherical region.

The divergent duct section 6 adjoins a hollow truncated-cone-shaped region downstream of its inlet opening from the convergent duct section 3, so that the flow cross section increases continuously in the direction of the rotor 8. This divergence ends in an again hollow cylindrical exit region of the divergent duct section 6, so that the flow 5 meets the blades of the rotor 8 at an entry angle of approximately 10°.

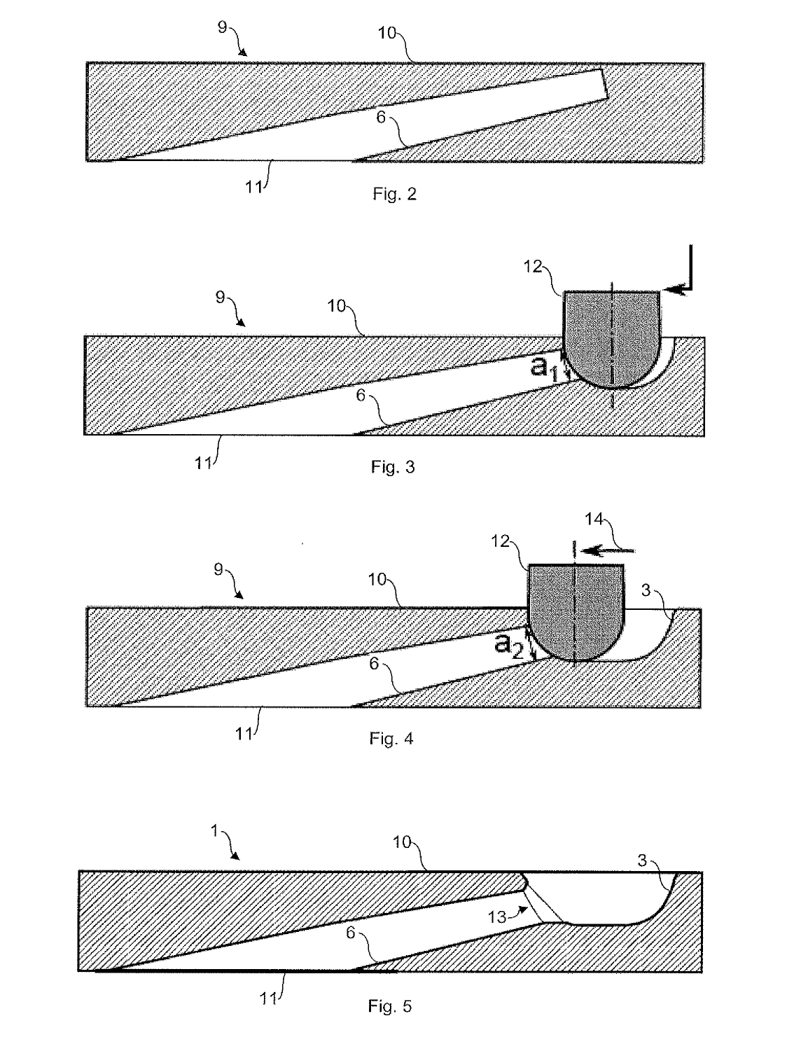

FIGS. 2 to 5 illustrate the production of a Laval nozzle 1 according to a second embodiment of the invention, similar to FIG. 1, consisting of a workpiece 9 in the form of a plate having an inlet side 10 and an outlet side 11 opposite the latter. FIG. 2 shows the state of the workpiece 9 after the machine-cutting of the outlet side 11, which initiates the method and in the course of which a divergent duct section 6 has been made in the workpiece 9.

Added to the scenario according to FIG. 3 is a rotating milling head 12, which has been sunk into the inlet side 10 to a predefined target depth and moved at right angles thereto along the inlet side 10 until first contact with the divergent duct section 6. This state allows the opening width a₁ to be determined already, which can be used as the calculation basis for the further transverse movement of the milling head 12.

If the milling head 12 has reached its final position as shown in FIG. 4, the opening assumes a slightly increased geometric final width a₁ compared with the initial opening width a₁, which final width defines the smallest flow cross section of the working fluid when passing through the resulting Laval nozzle 1. If the milling head 12 is then raised and the opening 13 is suitably jet-cut or post-machined in another manner, the Laval nozzle 1 obtains its final shape as shown in FIG. 5.

1. A Laval nozzle comprising:
a convergent duct section having a first longitudinal axis, for accelerating a flow of a working fluid from a subsonic speed to a sonic speed, and
a divergent duct section, which is fluid-connected to the convergent duct section and has a second longitudinal axis, for further accelerating the flow from the sonic speed to a supersonic speed, wherein the convergent duct section and the divergent duct section are aligned with respect to each other such that the first longitudinal axis intersects the second longitudinal axis.

2. The Laval nozzle according to claim 1, wherein the convergent duct section and the divergent duct section are aligned with respect to each other such that the first longitudinal axis intersects the second longitudinal axis at an intersection angle between 5° and 85°.

3. The Laval nozzle according to claim 1, further comprising a short section having a constant narrow cross section arranged between the convergent duct section and the divergent duct section.

4. A turbine comprising
a rotatably mounted output shaft for discharging mechanical output work of a working fluid, and
at least one rotor, which is mechanically connected to the output shaft, for rotating the output shaft via a flow of the working fluid,
at least one Laval nozzle fluidically-connected to the rotor for introducing the flow into the rotor, the Laval nozzle including:
a convergent duct section having a first longitudinal axis for accelerating the flow of the working fluid from a subsonic speed to a sonic speed; and
a divergent duct section fluidically-connected to the convergent duct section, the divergent duct section having a second longitudinal axis for accelerating the flow from the sonic speed to a supersonic speed;
wherein the convergent duct section and the divergent duct section are arranged such that the first longitudinal axis intersects the second longitudinal axis.

5. The turbine according to claim 4, wherein the divergent duct section and the rotor are aligned with respect to each other such that the Laval nozzle introduces the flow into the rotor at an entry angle between 5° and 45°.

6. The turbine according to claim 4, further comprising another Laval nozzle, wherein the two Laval nozzles are fluid-connected to the rotor.

7. A method for producing a Laval nozzle from a workpiece having an inlet side and an outlet side opposite the inlet side, comprising:
shaping the workpiece by machine-cutting on the inlet side along a first longitudinal axis and on the outlet side along a second longitudinal axis that intersects the first longitudinal axis, wherein the shaping takes place such that a convergent duct section, which opens into the inlet side, and a divergent duct section, which is connected to the convergent duct section and opens out of the outlet side, are produced in the workpiece.

8. The method according to claim 7, wherein the shaping is performed via a geometrically defined edge.

9. The method according to claim 8, wherein the shaping takes place initially on the outlet side and then on the inlet side.

10. The method according to claim 9, wherein the shaping includes:
rotating a ball-cutting tool in a sinking movement into the inlet side to a predefined target depth,
performing a first transverse movement, which is directed substantially transversely to the sinking movement of the ball-cutting tool, in the inlet side until the convergent duct section and the divergent duct section connect in an opening,
measuring a geometric opening width of the opening,
determining a geometric distance from the measured opening width and a predefined geometric final width of the opening, and
aligning a second transverse movement with the first transverse movement by the determined distance.

11. The method according to claim 10, further comprising post-machining the opening via a geometrically undefined edge.

12. The Laval nozzle according to claim 2, further comprising a short section having a constant narrow cross section arranged between the convergent duct section and the divergent duct section.

13. The turbine according to claim 4, wherein the convergent duct section intersects with the divergent duct section at an intersection angle between 5° and 85°.

14. The turbine according to claim 13, further comprising a short section having a constant narrow cross section arranged between the convergent duct section and the divergent duct section.

15. The turbine according to claim 4, further comprising a short section having a constant narrow cross section arranged between the convergent duct section and the divergent duct section.

16. The turbine according to claim 5, further comprising another Laval nozzle fluidically-connected to the rotor.

17. The turbine according to claim 5, wherein the convergent duct section intersects with the divergent duct section at an intersection angle between 5° and 85°.

18. The turbine according to claim 17, further comprising a short section having a constant narrow cross section arranged between the convergent duct section and the divergent duct section.

19. The turbine according to claim 18, further comprising another Laval nozzle fluidically-connected to the rotor.

20. The turbine according to claim 6, wherein the convergent duct section of at least one Laval nozzle intersects with the divergent duct section at an intersection angle between 5° and 85°.
